(19) United States
(12) Patent Application Publication
(10) Pub. No.: US 2021/0048292 A1
(43) Pub. Date: Feb. 18, 2021

(54) Autonomous Instrument For Scanning And Determining The Material Surface Roughness

(71) Applicant: STC Rainforest Innovations, Albuquerque, NM (US)

(72) Inventors: Ishtiaque Anwar, Albuquerque, NM (US); John Stormont, Albuquerque, NM (US); Mahya Hatambeigi, Albuquerque, NM (US)

(73) Assignee: STC Rainforest Innovations, Albuquerque, NM (US)

(21) Appl. No.: 16/991,957

(22) Filed: Aug. 12, 2020

Related U.S. Application Data
(60) Provisional application No. 62/885,711, filed on Aug. 12, 2019.

(51) Int. Cl. G01B 11/30; G01B 5/28; G01B 11/00; G01B 5/016; B33Y 50/02; B29C 64/393; B33Y 10/00; B25J 9/12; B25J 9/02

(52) U.S. Cl. CPC G01B 11/30; G01B 5/28; G01B 11/005; G01B 5/016; B62D 63/04; B29C 64/393; B33Y 10/00; B25J 9/12; B25J 9/026; B33Y 50/02

(57) ABSTRACT

A system and device for recording the distance from a distance indicator to a sample over time to generate a 3D profile of the sample.

### RELATED APPLICATIONS

This application claims priority to U.S. Provisional Application Ser. No. 62/885,711 filed Aug. 12, 2019, which is incorporated herein in its entirety.

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### BACKGROUND OF THE INVENTION

Surface texture is a repetitive or random deviation from a nominal plane within a material that forms the topography. Surface profile information includes the data for surface roughness (micro), waviness (macro), lay, and flaws. There are specific parameters and standards for characterizing the surface, including the ones defined by the International Standard Organization (ISO) and the American National Standards Institute (ANSI). For instance, the value of average roughness (Ra) is an official standard in most industrialized countries.

A number of available techniques to measure the surface profile (or texture or roughness) include mechanical stylus method, optical methods (photogrammetry), electron microscopy method, and scanning probe microscopy (SPM) methods.

The commercially available mechanical stylus profilometers include an environmental enclosure that limits the size of the sample (generally up to 100 mm). In the case of the products with more stage movement freedom, stitching is needed every 200 mm of scanning. Moreover, the available mechanical profilers are not suitable for scanning rougher surfaces like cement and rocks, as their styli are designed for smooth surfaces like polished metals/minerals (with a gauge range limited to 5 mm). Besides, the available products are practical only for laboratory purposes and are not intended for producing field profiles (like outcrop surfaces), where more travel lengths are required.

Optical methods (photogrammetry) can be used for rough samples, but this method requires special techniques, expensive software/hardware components, excessive control over the ambient lighting, and has limitations in outdoor use. Sometimes with a slight variation in material surface coloration or lighting conditions (as in corrosion mapping or paint industry), photogrammetry may not be very useful. The material type, (e.g., conductive, reflective) can also affect the scanning performance of specific instruments. The limited output customization option of the available instruments is also an issue for some applications.

The high resolution (as low as 200 nm) photogrammetry using accelerated electrons as a source of illumination, as in electron microscopy, is not only limited to certain types of conductive materials but also lacks portability. These instruments are quite expensive. Again, scanning/transmission electron microscopy requires exclusive surface treatment/coating, precise instrument adjustments in SEM/TEM, and post-processing, which makes the technique expensive, slow, and thus ineffective just for acquiring surface topography.

SPM or atomic force microscopy (AFM) can also obtain quite high resolution (on the order of a fraction of nanometer) surface topography. But the maximum sample size (100 microns×100 microns) and the maximum variation in surface heights are limited for these instruments. Regular maintenance, the need for frequent stylus replacement and requirements for skilled operators make the measurements quite pricey as well.

Another system, called profilograph, is a widely used surface profiling instrument with low-speed rolling devices. It is an on-site pavement surface roughness measurement system with limited control options in probe travel length or sampling interval. This tool is not suitable for scanning relatively smaller samples, with the largest dimension less than 8 ft (approx.). Together with a reasonably higher degree of uncertainty, the lowest resolution of the latest system is about 1 mm, which makes the instrument ineffective for generating a topography with a resolution of about 1 micron and a comparatively smaller sample size.

### SUMMARY OF THE INVENTION

In one embodiment of the present, the present invention provides a method and device that may be used to characterize the surface texture of different materials in various applications. Surface characteristics are regularly used for purposes such as quality control applications, to assess the performance of mechanical devices, characterization of flow path geometry, integrity tests/measurement verifications in the construction industry, automobile industry, manufacturing processes, scientific studies concerning both experimental work and computer-based modeling, etc.

In other embodiments, the present invention provides an autonomous system to accurately measure and create 3D representations of any material surface and almost any dimensions.

In other embodiments, the present invention provides an autonomous system capable of being used on large sample surfaces with multiple compounds/minerals.

In other embodiments, the present invention provides an autonomous system capable of being used on sample surfaces with micro and macro variations.

In other embodiments, the present invention provides an autonomous system capable of being used on sample surfaces with micro and macropores.

In other embodiments, the present invention provides an autonomous system capable of being used on sample surfaces that require controlled temperature.

In other embodiments, the present invention provides an autonomous system capable of achieving high-resolution measurements as low as 1 micron.

In other embodiments, the present invention provides an autonomous system capable of scanning a comparatively bigger sample area.

In other embodiments, the present invention provides an autonomous system that is economical, affordable, and customizable per emerging needs.

In other embodiments, the present invention provides an autonomous system capable of having an automated data collection and processing system.

In other embodiments, the present invention provides an autonomous system capable of having special indicators for different surfaces eliminating frequent maintenance.

In other embodiments, the present invention provides an autonomous system capable of obtaining 3d topography of a relatively large specimen with a resolution as low as 1 micron.

In other embodiments, the present invention provides an autonomous system capable of scanning a surface with corrosion.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1A is a schematic of an embodiment of the present invention.

FIG. 1B is a simplified diagram of an embodiment of the present invention.

FIG. 1C is another diagram of an embodiment of the present invention.

FIG. 2 illustrates various styli for an embodiment of the present invention.

FIG. 3 is a schematic of a conical stylus that may be used with the embodiments of the present invention.

FIG. 4 illustrates a non-contact laser-based indicator with multiple aperture optical arrangement that may be used with the embodiments of the present invention.

FIG. 5 illustrates the scanning of a rough surface using a contact system for an embodiment of the present invention.

FIG. 6 illustrates a 2D surface profile generated using an embodiment of the present invention.

FIG. 7 illustrates a 3D surface profile generated using an embodiment of the present invention.

### DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

In one embodiment, the present invention provides methods, systems, and devices designed to handle and overcome the limitations described herein. In certain aspects, to enable the scanning of a larger sample, the embodiments of the present invention use indicators that measure the deviations in heights (ranging up to 25.4 mm) for a relatively large surface area. The minimum viable product (MVP) is capable of scanning a sample area of (400 mm×400 mm), which can be increased in need.

A majority of the commercially available instruments are not capable of practically handling larger sample sizes which are required in applications such as in construction industries, manufacturing industries, large scale research facilities, representative scientific studies etc. Furthermore, in many cases, the sample movement is not possible or cumbersome. This necessitated the need for a portable, accurate surface profiler. In certain embodiments of the present invention, only the movement of the indicator (a device for measuring height variation) is controlled, and thus it is portable for any in-situ measurements.

In addition, the resolution of the surface measurement becomes more important as the level of the roughness decreases, and this inevitably causes an increase in the cost of the currently available instruments. Unlike current solutions, the embodiments of the present invention are low-cost systems that are capable of measuring a wide range of roughness and can scan a heterogeneous surface that consists of both smooth and rough surfaces. Furthermore, an autonomous scanner, when used with the present invention, will require less time and minimal supervision, which will undoubtedly increase workforce efficiency. The embodiments of the present invention consist of both hardware units as well as computer code.

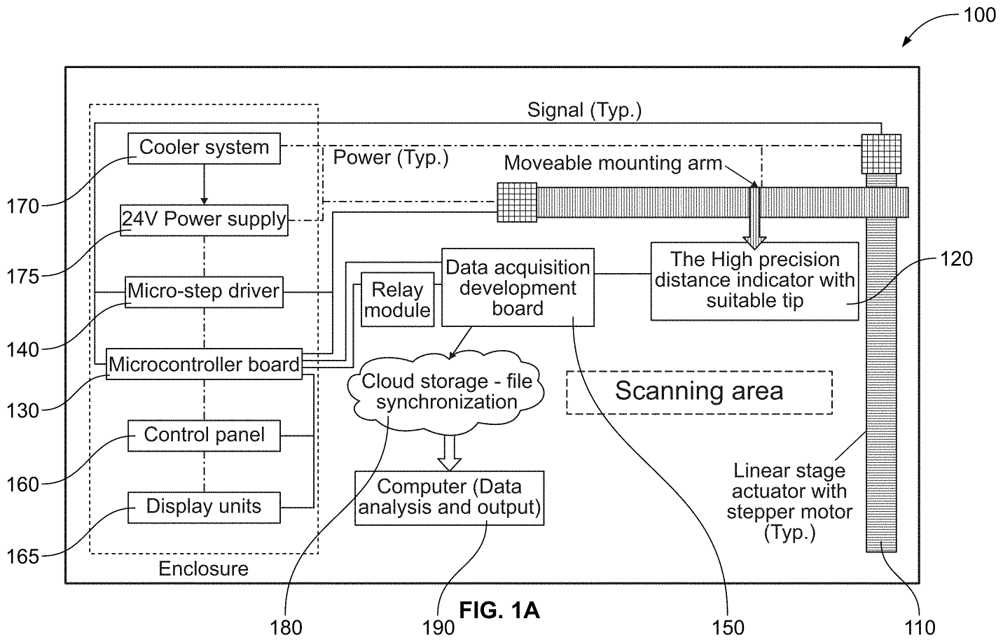

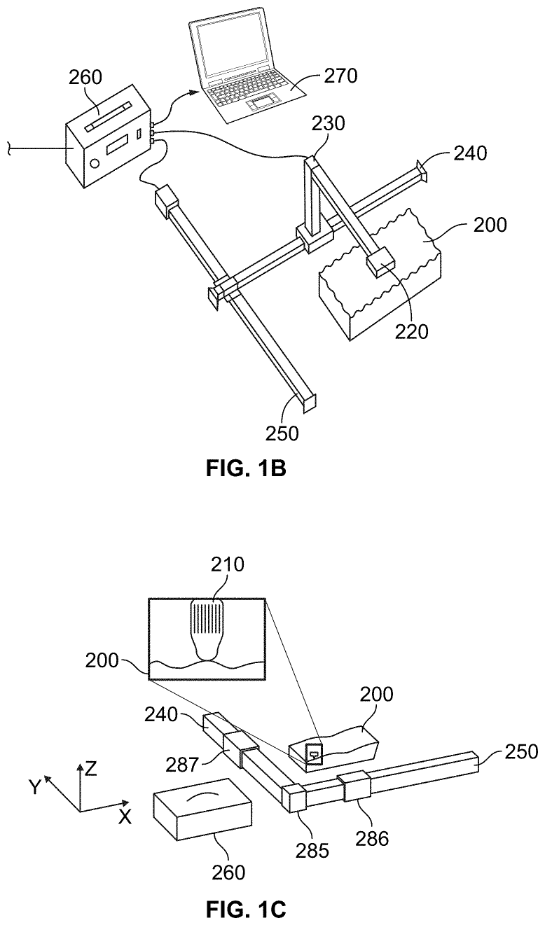

In a preferred embodiment, as shown in FIG. 1A, hardware components may include: linear stage actuator with stepper motor 110 with attached stylus 115; high precision distance indicator 120; microcontroller board with processor 130; micro-stepper 140; data acquisition development board 150; control panel 160; one or more displays 165; cooler system 170; power supply 175; data storage which may be cloud-based system 180; and computer (Data analysis and output) 190.

As shown in FIGS. 1B and 1C, in other embodiments, sample 200 is located below stylus 210 which is connected to distance indicator or sensor 220 which in turn is connected to the distal end of movable arm 220 to be located above and away from arms 250 and 240. Indicator or sensor 220 is movable in the Z-axis or is stationary.

Movement in the X and Y axes is achieved by linear actuators 240 and 250. Processing unit 260 controls movement in the X, Y, and Z axes and is also in communication with sensor or indicator 220. Processing unit 260 also is in communication with processor or computer 270. In other embodiments, stepper motor 285 may control the movement of arms 240 and 250 along with indicators 286 and 287 which indicate the distance moved.

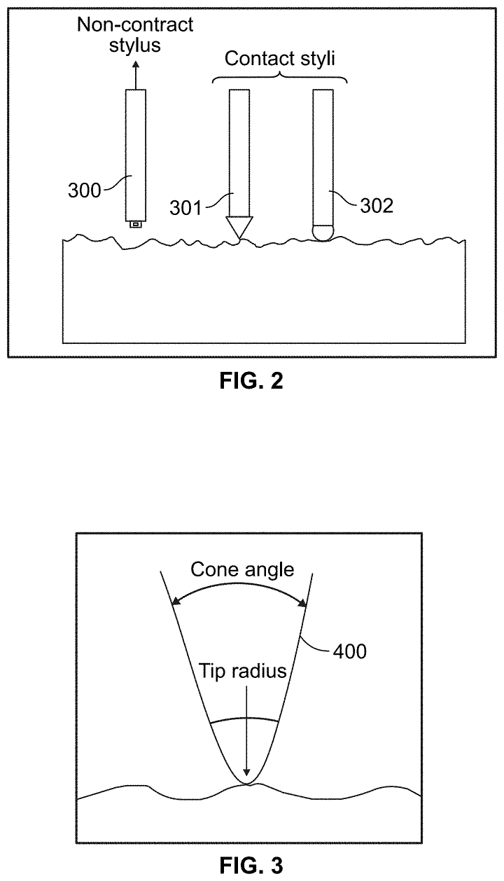

As shown in FIG. 2, the instrument is capable of being mounted with different styli 300-302 to accommodate different roughness applicable for both contact and non-contact ones. Non-contact styli 300 may be a laser designed to measure distance as discussed below. Contact style 301 and 302 may include conical styli 301 and spherical head styli 302 are most affordable and almost exclusively used for microroughness measurements. Conical tip styli can capture the minimal roughness variations. But in some material surfaces, this sharp-pointed stylus may cause local deformation which leads to damage and results in measurement errors. For certain materials, the spherical head styli are necessary for the smooth transition of the indicator. In contact-based embodiments, both types of styli are available and interchangeable.

As shown in FIG. 3, beside the regular conical and spherical head styli, the present invention may also use modified stylus 400 with a cone angle 310 from 60° to 90° (±2°) and tip radius 320 ranging from 0.1 to 25 micron, which is in accordance with ISO standard. The tip radius and cone angle are chosen based on the application of the stylus, roughness of the material and shape of the surface

Non-contact laser-based indicator 300 is used where the higher resolution measurements are required without a mechanical contact of the stylus point with the material surface. The use of the laser enables highly accurate measurements on a variety of surfaces with sharp angles and a wide range of material from metal to black rubber, even when the target is a mixture of different colors and finishes. Such indicator uses single or multiple aperture optical arrangement with an appropriate focus lens to capture data for a variety of material surfaces without compromising the accuracy. The resolution of the non-contact indicator can be as low as 1 nm, based on the need.

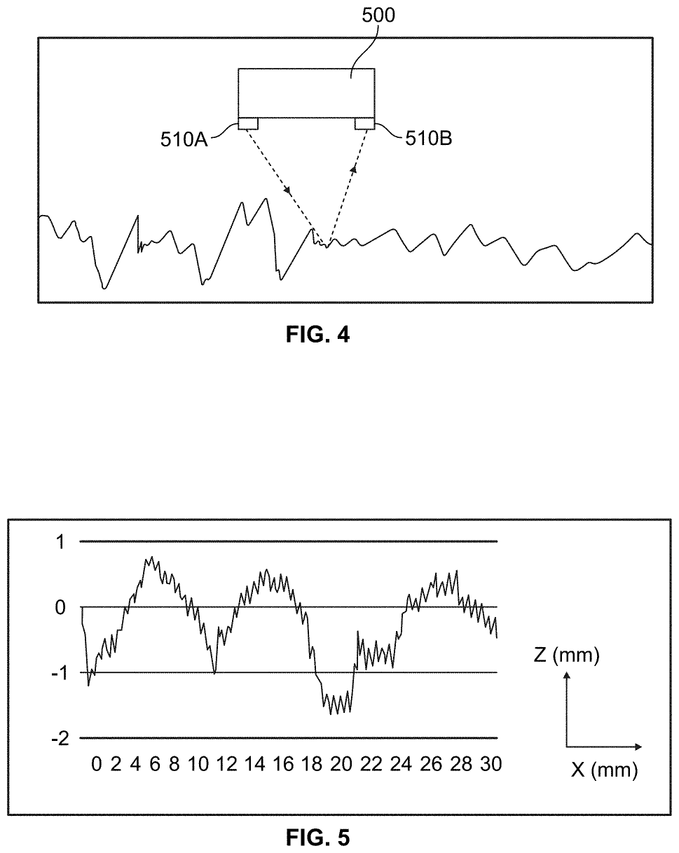

As illustrated in FIG. 4, in another embodiment, the present invention provides a simplified mechanism of a non-contact laser-based indicator 500. Laser 500 includes a plurality of aperture optical arrangements 510A and 510B that provide the necessary data to determine the distance between the laser and sample.

A preferred embodiment of the present invention includes moving parts in three orthogonal directions (X, Y, and Z); the resolution of the system is as low as 1 micron in any of the directions. The directions are illustrated in FIG. 5. Movement of the system in X and Y directions (in the plane of the surface) is driven by two stepper motors and a microcontroller that controls the step motors through a micro-step driver and enables the micro-movement of the linear actuator. The variations of the material surface are measured (in the Z direction) by the movement of the indicator which can be a contact (needle with desired tip diameter) or a non-contact distance indicator (IR, laser, etc.).

A control panel 260 may be used to enable secure handling of the instrument without the necessity of frequent adjustment of the embedded complex computer code of the system. In one set up, the control panel allows the user to navigate the indicator on top of the surface, as necessary. A data acquisition development board may also be used in conjunction with a relay module to collect and log the data from the indicator to the system.

To autonomously record the surface height variations during the actuator movement, software may be used with the microcontroller to synchronize the movement of the indicator with the data collection at desired sampling intervals. The obtained data is then forwarded to computer 270 through cloud-based storage as a final output.

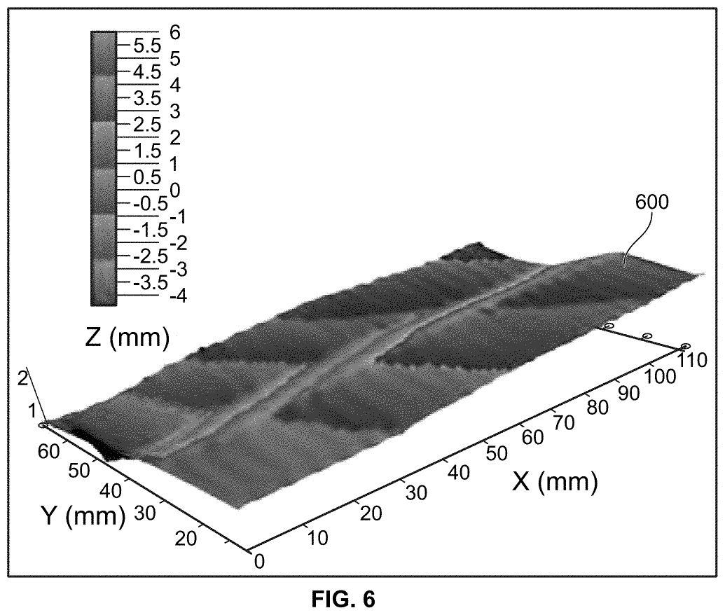

The X, Y, and Z coordinates of each reading together with the timestamp is displayed on the output screen. Using an embedded computer code, a real-time 2D plot of each profile and the standard surface roughness parameters may be produced. A 2D plot 600 is presented in FIG. 6, where the height variations in the Z direction were found to be as low as 1 micron.

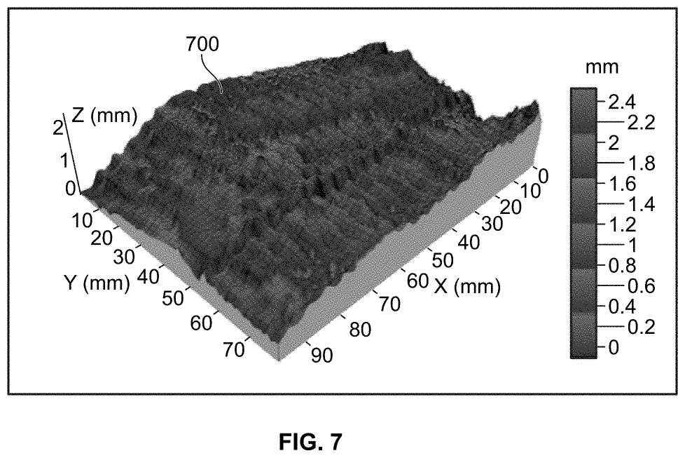

FIG. 7 presents the 3D surface from the scanning of a complete surface (wellbore cement fracture) with a variation in heights (Z direction) up to 10 mm. The image was generated from obtained data and rendered using third-party software. The whole scanning process including setup took less than an hour.

The embodiments of the present invention discussed above provide a tool for assessing the material surface topographies and provides high levels of accuracy for applications where surface properties are an essential indicator of product performance. Surface characteristics are regularly used for quality control applications and to assess the performance of mechanically mating surfaces in industry. Properties of surfaces are crucial to surface interaction because surface characteristics affect the contact area, friction, lubrication, and wear. Furthermore, surface characteristics are important in optical, electrical, and thermal performance, painting, and appearance. For example, surface roughness parameters of technological equipment, such as the internal surfaces of a vertical conical mixing unit and its components, are used in the food industry to confirm the correctness of the manufacturing process.

Surface roughness is one of the most important factors that affect the hydromechanical behavior of fluid flow through porous media, including fractures in rocks, wellbore cement, and concrete. The surface data acquisition system must be suitable for any particular purpose. For instance, micro, or even nano-scale roughness may be needed to be detected in the case of metal surfaces. On the other hand, the rougher surfaces like cement, rock, and concrete need to be characterized by order of mm or cm.

An advantage of the invention is that it is suitable for mapping any large heterogeneous materials with both smooth and rough surfaces. The indicator can be chosen based on the requirements of the application, and thus, it can be used for a wide variety of materials and purposes.

Other components that may be used with the present invention include accessories such as built-in camera that generates an optical image of the entire surface together with the 3D surface profile. Compact housing and the integrated display screen will be useful not only to enhance the portability of the system but also to improve the user interface.

Wireless data acquisition system may be used for the simultaneous collection and analysis data from multiple set-ups. With further modifications, the remote-control automated system can be added as well, for operating the device in restricted access areas.

Other embodiments are capable of interfacing with 3D printing. For example, in conjunction with the 3D printing system, the present invention may be used for an instant quality check of each layer and instruct the printing machine accordingly for immediate repair of issues. This will enhance the performance and efficiency of both smaller and larger printing jobs.

Other embodiments may include an unmanned miniature vehicle designed to be remotely controlled or rover autonomously through the software-controlled pathway and broadcast the surface roughness data of single or multiple large surfaces in conjunction with onboard sensors and GPS.

It is to be understood that both the foregoing general description and the following detailed description are exemplary and explanatory only and are not restrictive of the invention, as claimed. Moreover, while the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. A system for characterizing the surface texture of different materials in various applications comprising:
a first linear stage actuator;
a second linear stage actuator;
said linear stage actuators operated by a stepper motor;
a movable arm connected to one of actuators and having a distal end that is located above and away from the actuator; and
at least one distance indicator connected to said distal end.

2. The system and device of claim 1 further including at least one microcontroller board with processor; at least one micro-stepper; at least one data acquisition development board; and at least one control panel.

3. The system and device of claim 1 further including different styli on said distance indicator to accommodate different roughness, wherein said styli have a conical or spherical tip.

4. The system and device of claim 3 further including a non-contact laser-based distance indicator.

5. The system and device of claim 1 wherein said actuators and movable arm are adapted for movement in three orthogonal directions (X, Y, and Z) with a resolution as low as 1 micron in any of the directions.

6. The system and device of claim 5 wherein movement of the system in X and Y directions is driven by two stepper motors and a microcontroller that controls the step motors through a micro-step driver and enables the micro-movement of the linear actuator.

7. The system of claim 6 wherein a plurality of readings corresponding to the X, Y, and Z coordinates of said distance indicator is made with each reading timestamped.

8. The system of claim 7 further including a display on which a 3D representation of a surface plot is shown.

9. The system of claim 8 further including at least one camera to generate an optical image of the surface of a sample together with the 3D surface profile of a sample.

10. The system of claim 1 adapted to provide data to a 3D printer.

11. The system of claim 1 including an unmanned vehicle designed to be remotely controlled.

12. The system of claim 1 wherein said system has deviations in heights of a sample range up to 25.4 mm.

13. The system of claim 1 wherein said system is capable of scanning a sample area of 400 mm×400 mm.

14. The system of claim 1 wherein said distance indicator includes a laser.

15. The system of claim 1 wherein said distance indicator includes a laser having a resolution of surface deviations as low as 1 nm.

16. A method for characterizing the surface texture of different materials in various applications, comprising the following steps:
providing a system comprising: a first linear stage actuator, a second linear stage actuator, said linear stage actuators operated by a stepper motor;
a movable arm connected to one of said actuators and having a distal end that is located above and away from the actuator with at least one distance indicator connected to said distal end;
moving said distance indicator in three orthogonal directions (X, Y, and Z); and
recording the distance from said distance indicator to the sample over time to generate a 3D profile of the sample.

17. The method of claim 16 further including the step of printing a 3D representation of said sample.

18. The method of claim 16 wherein said distance indicator includes a laser having a resolution of surface deviations as low as 1 nm.

19. The method of claim 16 wherein a plurality of readings corresponding to the X, Y, and Z coordinates of said distance indicator is made.

20. The method of claim 16 wherein a plurality of readings corresponding to the X, Y, and Z coordinates of said distance indicator is made with each reading timestamped.
